(19) United States
(12) Patent Application Publication
(10) Pub. No.: US 2019/0041012 A1
(43) Pub. Date: Feb. 7, 2019

(54) CANDLE AND WAX POOL THEREOF

(71) Applicant: Jian FANG, Dongguan (CN)

(72) Inventor: Jian FANG, Dongguan (CN)

(21) Appl. No.: 15/835,441

(22) Filed: Dec. 7, 2017

(30) Foreign Application Priority Data
Aug. 1, 2017 (CN) 201710656394.X

(51) Int. Cl. F21S 6/00; F21S 10/06; F21S 10/00; F21V 9/12

(52) U.S. Cl. CPC F21S 6/001; F21S 10/06; F21V 9/12; F21S 10/005; F21S 10/002

(57) ABSTRACT

The present disclosure provides a wax pool and a candle thereof. The wax pool is located on the top of the candle, the candle has at least a candle simulator, the wax pool is a light-transparent member, a reflection member or a 3D decoration member, the wax pool encircles the candle flame simulator. The candles using such wax pool in the present disclosure show molten state and gorgeous colors that are generated by the burning of traditional candles.

### CROSS-REFERENCE TO RELATED APPLICATIONS

This application claims priority to Chinese Patent Application No. 201710656394.X with a filing date of Aug. 1, 2017. The content of the aforementioned applications, including any intervening amendments thereto, are incorporated herein by reference

### TECHNICAL FIELD

The present disclosure relates to a field of electronic candles, and in particular to a candle and a wax pool thereof.

### BACKGROUND OF THE PRESENT INVENTION

With the continuous development of society, the quality of people's life continues to improve. For the sake of excellent quality of life, people become increasingly pernickety about the indoor environment quality. In order to create a comfortable and elegant atmosphere of life, people often light candles to enhance the indoor atmosphere. However, for traditional candles, after they are lit, the candles easily ignite flammable materials so as to cause a fire because of people' negligence So there's a certain security risk by using traditional candles whereby environmental pollution is caused too. What's more, traditional candles usually become so hot in burning process that people can't touch directly, otherwise, people will be scalded by wax or flame. In addition, traditional candles have a very short service life and can only maintain a short burning time. Therefore, the electronic flash wax candles, electronic candles and simulated candles and other electronic light-emitting device came into being.

In a burning process of traditional candles, the wax around the candlewick melts gradually and forms molten wax liquid and shows gorgeous colors in the candlelight. However, the prior electron light-emitting devices are difficult to show molten state and gorgeous colors that are produced by the burning of the traditional candles.

### SUMMARY OF PRESENT INVENTION

The present disclosure relates to a wax pool, aims to make the candle use such wax pool to exhibit molten state and gorgeous colors that are produced by the burning of the traditional candles.

To realize the above aim, the present disclosure relates to a wax pool, the wax pool located on a top of a candle, the candle includes at least a candle flame simulator. The wax pool is a light-transparent member, a reflection member or a 3D decoration member. The wax pool encircles the candle flame simulator device thereof.

Furthermore, the wax pool is provided with a through hole, the candle flame simulator is at least partially accommodated in the through hole, or adjacent to the through hole; and/or, the materials of the light-transmitting member are transparent plastic, translucent plastic, jelly wax, transparent wax, translucent wax, or glass; and/or, the wax pool has a gelatinous structure; and/or, the wax pool contains fragrance, essential oil, or insect repellent; and/or, the material of the reflecting member is mirror glass; or, the surface of the reflecting member is an annular member coated with a reflective layer.

Furthermore, the wax pool is accommodated in a holder.

Furthermore, the holder includes a basement and a bulge which is provided at a center of the basement. The basement and the bulge together form an accommodation space of the wax pool, the bulge passes through the through hole on the wax pool.

Furthermore, the bulge is provided with an opening, the basement is provided with a hole to communicate with the opening of the bulge, the candle flame simulator passes through the opening and the hole; or, the candle flame simulator is disposed adjacent to the opening and the hole device thereof.

Furthermore, the holder also includes a side wall which is located on a periphery of the basement. The basement, the side wall and the bulge together form the accommodation space.

Furthermore, the basement, the side wall and the bulge are provided with a heating plate.

The present disclosure also provides a candle, which includes a shell, the candle also includes the wax pool, which is provided at a top of the shell.

Furthermore, the top of the shell is provided with a holding tank, the wax pool is accommodated in the holding tank; and/or, the candle further includes a circuit board, a luminous part and a battery pack; the battery pack, the luminous part and the circuit board are electrically connected.

Furthermore, the candle flame simulator is fixed on a central position at the top of the shell; or, the candle flame simulator is accommodated in the shell; or, the shell is provided with a hole, the candle flame simulator is accommodated in the hole swingingly.

In the technical solution of the present disclosure, the wax pool is disposed at the top of the candle, and the wax pool encircles the candle flame simulator, and the wax pool is a light-transparent member, a reflection member or a 3D decoration member. The light that is produced by the burning candle shines to the wax pool by use of the candle flame simulator. When the light passes through the wax pool, the phenomenon of transmission, reflection, or transmission and reflection will occur, thus the candle flame simulator surrounded by the wax pool shows molten state similar to that is produced by the burning of candlewick of traditional candles. What's more, the wax pool exhibits gorgeous colors and simulates the flame that is generated by the burning of traditional candles. When the wax pool acts as the 3D decoration member, it shows molten state and gorgeous colors that are generated by the burning of traditional candles, it also shows 3D patterns, and simulates the flame that is generated by the burning of traditional candles at the same time.

### DESCRIPTION OF THE DRAWINGS

To illustrate the technical solution according to the embodiments of the present disclosure or in the prior art more clearly, the accompanying drawings for describing the embodiments or the prior art are introduced briefly in the following. Apparently, the accompanying drawings in the following description are only about some embodiments of the present disclosure, and those of ordinary skill in the art can derive other drawings from the accompanying drawings without creative efforts.

FIG. 1 is a structural schematic diagram of an embodiment of the wax pool of the present disclosure;

FIG. 2 is a structural schematic diagram of a candle with the wax pool in the first embodiment shown in FIG. 1;

FIG. 3 is an exploded diagram of the candle shown in FIG. 2;

FIG. 4 is a structural schematic diagram of an embodiment of the holder of the wax pool of the present disclosure;

FIG. 5 is a structural schematic diagram of the candle with the holder in the second embodiment shown in FIG. 4;

FIG. 6 is an exploded diagram of the candle shown in FIG. 5;

FIG. 7 is a structural schematic diagram of the third embodiment of the present disclosure;

FIG. 8 is a structural schematic diagram of the fourth embodiment of the present disclosure;

### LABEL DECLARATION OF THE FIGURES

| label | name |
|---|---|
| 100 | wax pool |
| 11 | through hole |
| 13 | holder |
| 131 | basement |
| 133 | bulge |
| 1331 | opening |
| 135 | side wall |
| 200a/200b/200c/200d | candle |
| 21a/21b/21c/21d | shell |
| 211a/211b | hole |
| 23a/23b | salient |
| 30a/30b | movement component |
| 31a/31b/31c/31d | candle flame simulator |
| 33a/33b | movement |
| 50a/50b | battery pack |
| 70b | circuit board |

Objective achieving, function features, and advantages of the present disclosure are further described with reference to the embodiments and the accompany drawings.

### DETAILED DESCRIPTION OF PREFERRED EMBODIMENTS

Technical solutions of the present disclosure are further described in detail with reference to the accompanying drawings and embodiments. It is to be understood that the specific embodiments described herein are merely used for describing the present disclosure, but are not intended to limit the present disclosure. Based on embodiments in the present disclosure, all other embodiments obtained by those of ordinary skill in the art without making creative work are within the scope of the present disclosure.

It should be noted that the directional terms (such as up, down, left, right, front and rear . . . ) in the embodiments of the present disclosure are merely used to explain the relative positions, the movement situation, etc. of each components in a particular gesture (as shown in the accompanying drawings), and if the particular posture changes, the directional terms also changes accordingly.

In addition, the description of “first”, “second” and the like in the present disclosure is used for the purpose of description only, and couldn't construed as indicating or implying its relative importance or implicating the number of the indicated technical features. Thus, the feature that defines “first”, “second” may expresses or implicates that it includes at least one of the described features. In addition, the technical solution between various embodiments are combined with each other, but must be based on the realization of those ordinary skill in the art. When the combination of technical solution arises contradictory or can not be achieved, the combination of such a technical solution should be considered as non-existent, and is not within the scope of the disclosure as claimed.

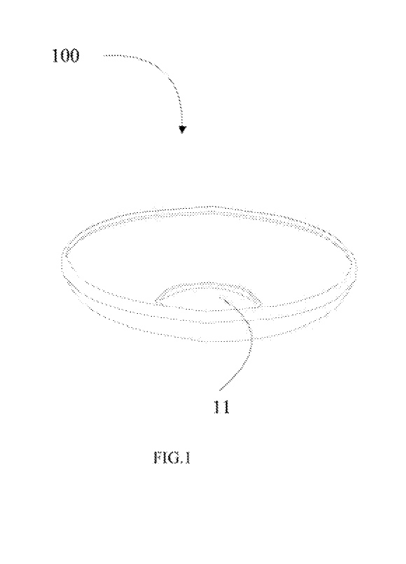

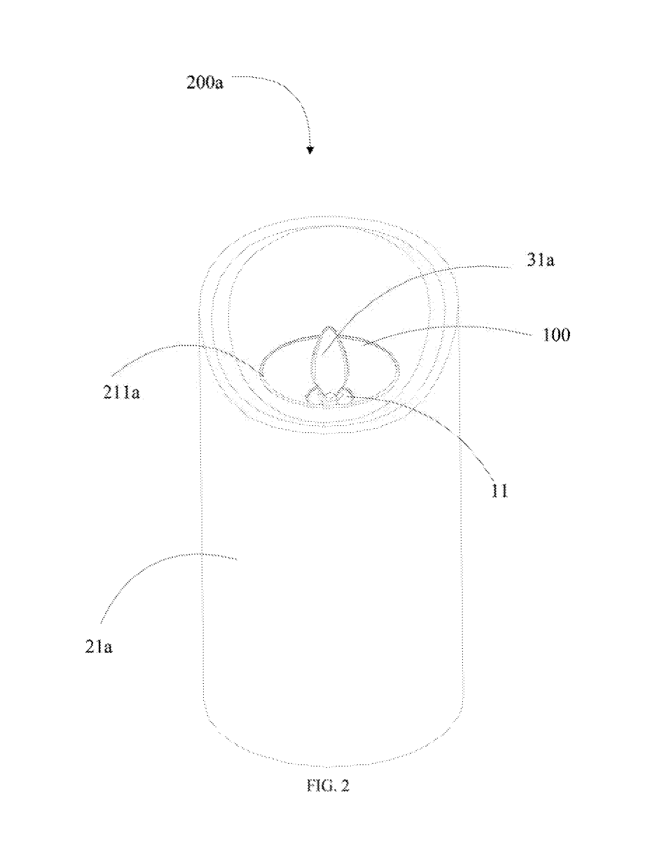

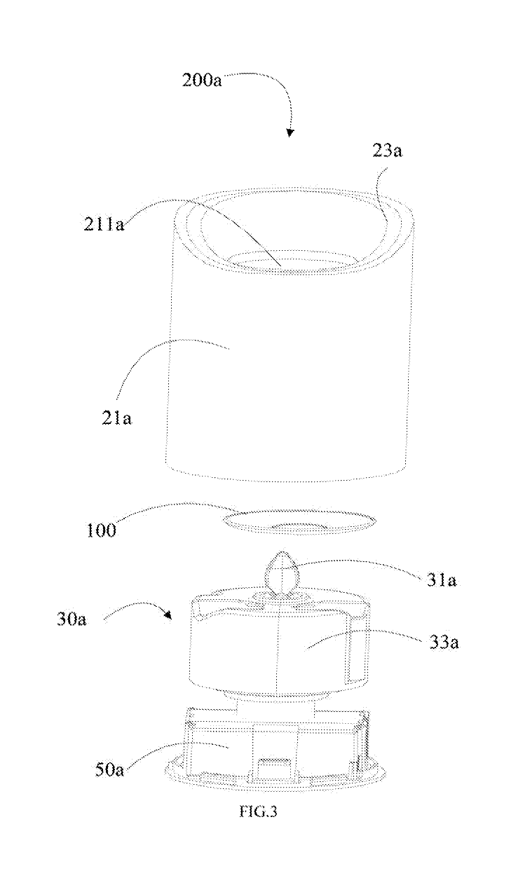

With reference to FIGS. 1 to 3, the present disclosure provides a kind of wax pool 100, which is provided at a top of the candle 200a in the first embodiment, the candle 200a includes at least a candle flame simulator 31a, the wax pool 100 is a light-transparent member, a reflection member or a 3D decoration member, the wax pool 100 encircles the candle flame simulator 31a.

It is understandable that the shape of wax pool is regular or irregular. In the first embodiment of the present disclosure, wax pool 100 is a regular ring structure, a cube structure with through-hole, a cuboid structure with a through-hole and so on. In another embodiment of the present disclosure, the wax pool 100 is an irregular polygonal structure.

In the first embodiment, the candle 200a includes a shell 21a, the shell 21a includes a cavity, and is provided with a hole 211a which is communicated with the cavity. The holder 13 and the wax pool 100 located on the holder 13 are accommodated in the hole 211a.

A holding tank is provided at a top of the shell 21a, the wax pool 100 is accommodated in the holding tank.

It is understandable that in another embodiment of the present disclosure, the shell 21a skips the hole 211a, the candle flame simulator 31a is fixed on a central position at the top of the shell 21a.

In another embodiment of the present disclosure, the shell 21a skips the hole 211a, the candle flame simulator 31a is accommodated in the shell 21a, the shell 21a is transparent or translucent.

In another embodiment of the present disclosure, the shell 21a has the hole 211a, the candle flame simulator 31a is accommodated in the hole 211a swingingly.

When the candle flame simulator 31a is accommodated in the hole 211a swingingly, the candle 200a also includes an external force generating device (not shown), the external force generating device is communicated with the candle flame simulator 31a, thus the external force generating device may drive the candle flame simulator 31a to swing.

It is understandable that the top of the shell 21a is curved salient 23a, to increase the aesthetics of the candle 200a.

It is understandable that the candle 200a is an electronic flash candle, an electronic candle or a simulated candle.

The candle 200a also includes a circuit board, a battery pack 50a and the circuit board are electrically connected.

In the first embodiment, the candle 200a also includes a movement component 30a and the battery pack 50a that are accommodated in the cavity, the movement component 30a includes the candle flame simulator 31a and the movement 33a, the candle flame simulator 31a is located on the movement 33a, the movement 33a also communicates with the battery pack 50a, the battery pack 50a provides electronic energy for the movement 33a to glows the luminous part of the movement 33a, the light shines to the candle flame simulator 31a and the candle flame simulator 31a exhibits the flame similar to that is produced by the burning of traditional candles.

In the technical solution of the present disclosure, the wax pool 100 is provided at the top of the candle 200a, and the wax pool 100 encircles the candle flame simulator 31a of the candle 200a, the wax pool 100 is a light-transparent member, a reflection member or a 3D decoration member.

The light produced by the burning candle 200a shines to the wax pool 100 by use of the candle flame simulator 31a. When the light passes through the wax pool 100, the phenomenon of transmission, reflection, or transmission and reflection will occur, thus the candle flame simulator 31a which is surrounded by the wax pool 100 shows molten state similar to that is produced by the burning of candlewick of traditional candles. Under light irradiation the wax pool 100 shows gorgeous colors and simulates the flame that is produced by the burning of traditional candles. When the wax pool 100 used as a 3D decoration member, not only shows molten state and gorgeous colors that are produced by the burning candlewick of traditional candles, but also presents a 3D pattern and simulates the flame that is produced by the burning of traditional candles.

The wax pool 100 is provided with a through hole 11, wherein the candle flame simulator 31a is at least partially accommodated in the through hole 11, or adjacent to the through hole 11.

In the technical solution of the present disclosure, the wax pool 100 is provided with the through hole 11, wherein the candle flame simulator 31a is at least partially accommodated in the through hole 11, thus lead to the wax pool 100 encircles the candle flame simulator 31a. Or the candle flame simulator 31a is provided adjacent to the through hole 11, preferably, the candle flame simulator 31a is provided adjacent to the through hole 11, and just below a center of the through hole 11, thus lead to the wax pool 100 encircles the candle flame simulator 31a.

The materials of the light-transmitting member are transparent plastic, translucent plastic, jelly wax, transparent wax, translucent wax or glass.

In the technical solution of the present disclosure, the light-transmitting member is transparent plastic, translucent plastic, jelly wax, transparent wax, translucent wax or glass, the light which is produced by the burning candle 200a shines to the light-transmitting member by using of the candle flame simulator 31a, to let the light-transmitting member exhibit the molten state that is produced by the burning of candlewick of traditional candles and the wax pool 100 shows gorgeous colors under the light irradiation.

The wax pool 100 contains fragrance, essential oil, or insect repellent.

In the technical solution of the present disclosure, the wax pool 100 contains fragrance, essential oil, or insect repellent, to make the candle 200a functional, such as sending out fragrance, essential oils and insect repellent components.

The wax pool has a gelatinous structure.

In the technical solution of the present disclosure, the wax pool 100 has a gelatinous structure, when the candle 200a works, the wax pool 100 with gelatinous structure shows molten state and simulates the melt state of wax melt encircles the candlewick.

The material of reflecting member is mirror glass; or the reflecting member is the loop-forming element and is coated with reflecting layer on the surface. Specifically, the reflecting layer is plastic parts, and the surface of the plastic parts is coated with reflecting layer.

In the technical solution of the present disclosure, the reflecting member is mirror glass; or, the reflecting member is the loop-forming element and is coated with reflecting layer on the surface, when the candle 200a works, the light would reflect to the reflecting member by using of the candle flame simulator 31a, the light is reflected by the reflecting member, thus let the wax pool 100 exhibit molten state that is produced by the burning of candlewick in traditional candles and the wax pool 100 shows gorgeous colors under the light irradiation.

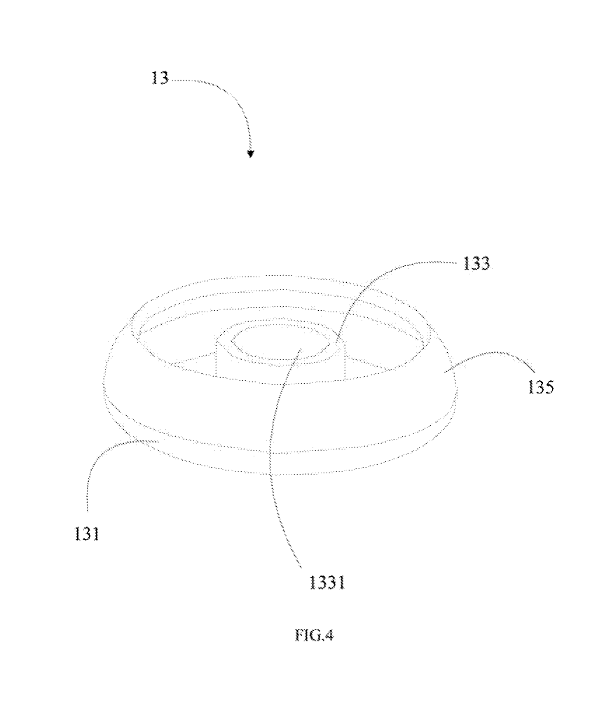

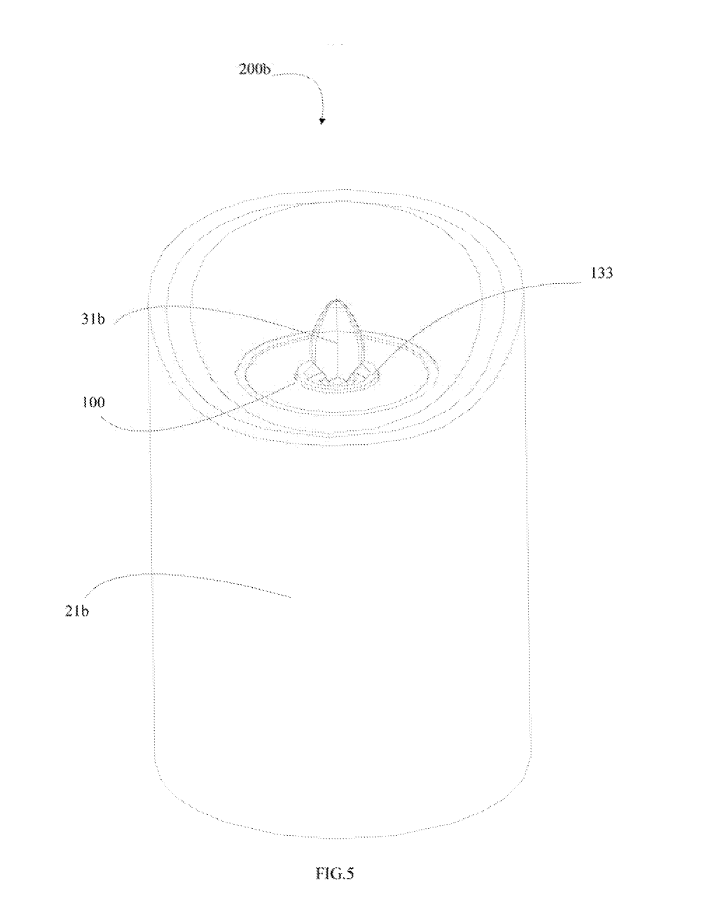

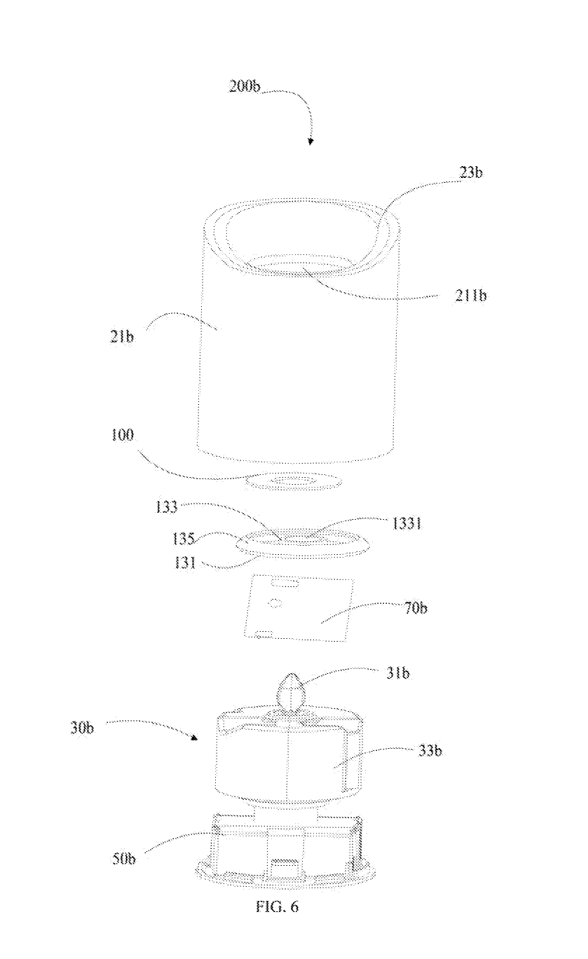

With reference to FIGS. 4 to 6, the wax pool 100 is accommodated in a holder 13, when provided the wax pool 100 and the holder 13 on the top of the candle, and then candle 200b in the second embodiment is emerged.

It is understandable that the holder 13 has a structure that is matched to the wax pool 100. It is understandable that the shape of the holder 13 is regular or irregular. In one of the embodiment, the holder 13 is a regular ring structure, a cube structure with through-hole, a cuboid structure with through-hole and so on. In another embodiment of the present disclosure, the holder 13 is an irregular polygonal structure.

The only difference between the candle 200b in the second embodiment and the candle 200a in the first embodiment is that the candle 200b in the second embodiment is provided with the holder 13.

The candle 200b in the second embodiment includes a shell 21b, the shell 21b includes a cavity, and is provided a hole 211b to communicate with the cavity, the holder 13 and the wax pool 100 which is located on the holder 13 is accommodated in the hole 211b.

A holding tank is provided at the top of the shell 21b, the wax pool 100 and the holder 13 are accommodated in the holding tank.

It is understandable that in one of the embodiment of the present disclosure, the shell 21b skips the hole 211b, the candle flame simulator 31b is fixed on a central position at the top of the shell 21b.

In another embodiment of the present disclosure, the shell 21b skips the hole 211b, the candle flame simulator 31b is accommodated in the shell 21b, the shell 21b is transparent or translucent.

In another embodiment of the present disclosure, the shell 21b has the hole 211b, the candle flame simulator 31b is accommodated in the hole 211b swingingly.

When the candle flame simulator 31b is accommodated in the hole 211b swingingly, the candle 200b also includes an external force generating device (not shown), the external force generating device is communicated with the candle flame simulator 31b, thus the external force generating device can drive the candle flame simulator 31b to, swing.

It is understandable that the top of the shell 21b is curved salient 23b, to increase the aesthetics of the candle 200b.

In the second embodiment, the candle 200b also includes movement component 30b and battery pack 50b that are accommodated in the cavity. The movement component 30b includes the candle flame simulator 31b and the movement 33b, the candle flame simulator 31b locates on the movement 33b, the movement 33b also communicates with battery pack 50b, the battery pack 50b provides electronic energy for the movement 33b to glows the luminous part of the movement 33b, the light shines to the candle flame simulator 31b and the candle flame simulator 31b exhibits the flame similar to that is produced by the burning of traditional candles.

It is understandable that candle 200b is electronic flash candle, electronic candle or simulated candle.

The candle 200b also includes circuit board 70b, the battery pack 50a and the circuit board are electrically connected.

In the technical solution of the present disclosure, the wax pool 100 is accommodated in the holder 13, so that the wax pool 100 is firmly accommodated in the holder 13.

In the technical solution of the present disclosure, the wax pool 100 is provided at the top of the candle 200b, and the wax pool 100 encircles the candle flame simulator 31b of the candle 200b, the wax pool 100 is a light-transparent member, a reflection member or a 3D decoration member. The light produces by the burning candle 200b shines to the wax pool 100 by using of the candle flame simulator 31b. When the light passes through the wax pool 100, the phenomenon of transmission, reflection, or transmission and reflection will occur, thus the candle flame simulator 31a surrounded by the wax pool 100 shows molten state similar to that is produced by the burning of candlewick in traditional candles.

Under the light irradiation, the wax pool 100 shows gorgeous colors and simulates the flame that is produced by the burning of traditional candles. When the wax pool 100 acts as a 3D decoration member, not only shows molten state and gorgeous colors that are produced by the burning candlewick of traditional candles, but also presents a 3D pattern and simulates the flame that is produced by the burning of traditional candles.

The holder 13 includes basement 131 and the bulge 133 which locates on a center of the basement, the basement 131 and the bulge 133 together form an accommodation space of the wax pool 100. The bulge 133 passes through the hole 11 in the wax pool 100.

In the technical solution of the present disclosure, the holder 13 forms a structure that is matched to the wax pool 100, making the wax pool 100 accommodate in the holder 13 firmly. Specifically, the holder 13 includes the basement 131, and the bulge 133 is located on the center of the basement, the basement 131 and the bulge 133 together form the accommodation space for accommodating the wax pool 100. The bulge 133 passes through the hole 11 of the wax pool 100. Furthermore, the bulge 133 may pass through the hole 11 of the wax pool 100, to communicate the holder 13 and the wax pool 100 securely.

It is understandable that the holder 13 is located on the top of the candle 200a, making the wax pool 100 firmly locate on the top of the candle 200a.

The bulge 133 is provided with an opening 1331, the basement 131 is provided with a hole that is communicated with the opening 1331, the candle flame simulator 31b passes through the opening 1331 and the hole; or, the candle flame simulator 31b is close to the opening 1331 and the hole.

In the technical solution of the present disclosure, the bulge 133 is provided with the opening 1331, the basement 131 is provided with a hole that is communicated with the opening 1331, the candle flame simulator 31b passes through the opening 1331 and the hole, making the wax pool 100 and the holder 13 encircle the candle flame simulator 31b, thus the light that is produced by working of the candle 200b shines to the wax pool 100 by take advantage of the candle flame simulator 31b, the opening 1331 and the hole, thus the wax pool 100 exhibits molten state that is produced by the burning of candlewick in traditional candles and the wax pool 100 shows gorgeous colors under the light irradiation.

Furthermore, the candle flame simulator 31b is adjacent to the opening 1331 and the hole. Preferably, the candle flame simulator 31b is near to the opening 1331 and the hole, right below a center of the opening 1331 and the hole, the wax pool 100 also encircles the candle flame simulator 31a. At this time, the light produced by working of the candle 200b shines to the wax pool 100 by taking advantage of the candle flame simulator 31b, the opening 1331 and the hole, thus let the wax pool 100 exhibit molten state that is produced by the burning of candlewick in traditional candles and the wax pool 100 shows gorgeous colors under the light irradiation.

The holder 13 also includes a side wall 135 which is located on the periphery of the basement 131, the basement 131, the side wall 135 and the the bulge 133 together form the accommodation space.

It is understandable that the inner or outer surface of the holder 13 is provided with a heating plate (not shown). When the wax pool 100 contains fragrance, essential oil, or insect repellent. The heating plate may heat the wax pool 100, to volatilize the fragrance, essential oil, or insect repellent.

Specifically, it provides the heating plate on inner or outer surface on one of the basement 131, the bulge 133 or the side wall 135.

In the technical solution of the present disclosure, the holder 13 also includes the side wall 135 which is located on the periphery of basement 131. The basement 131, the side wall 135 and the bulge 133 together form accommodation space, herein to increase the stability of the connection between the wax pool 100 and the holder 13.

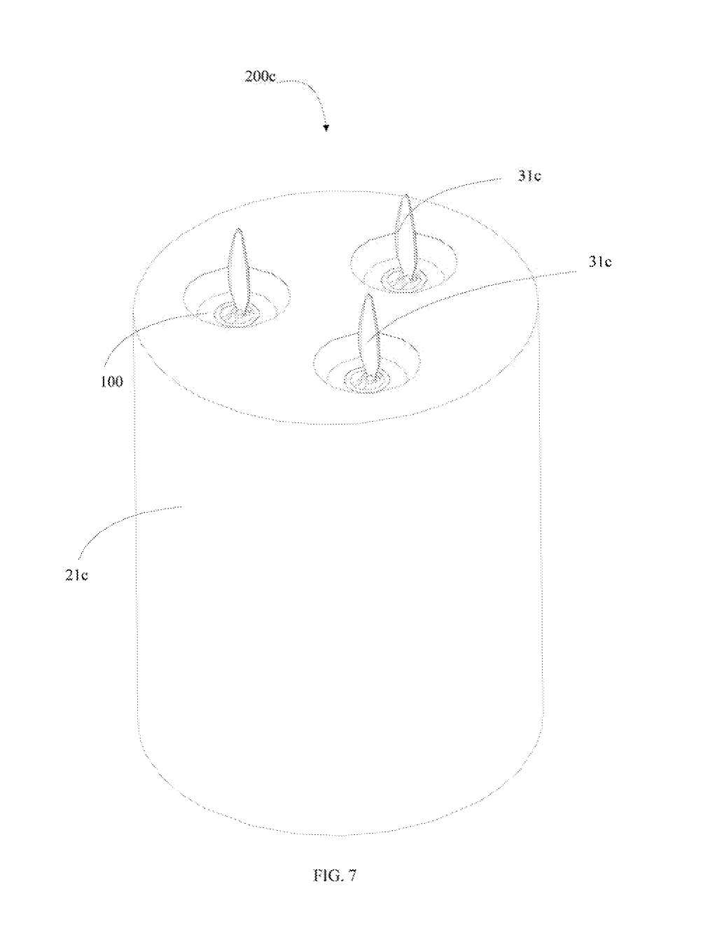

With reference to FIG. 7, the only difference between the candle 200c in the third embodiment and the candle 200a in the first embodiment is that the top of the shell 21c of the candle 200c in the third embodiment skips a curved salient, and the candle 200c in the third embodiment has several candle flame simulators 31c.

It is understandable that the candle flame simulator 31c in the third embodiment is located on the shell 21c swingingly.

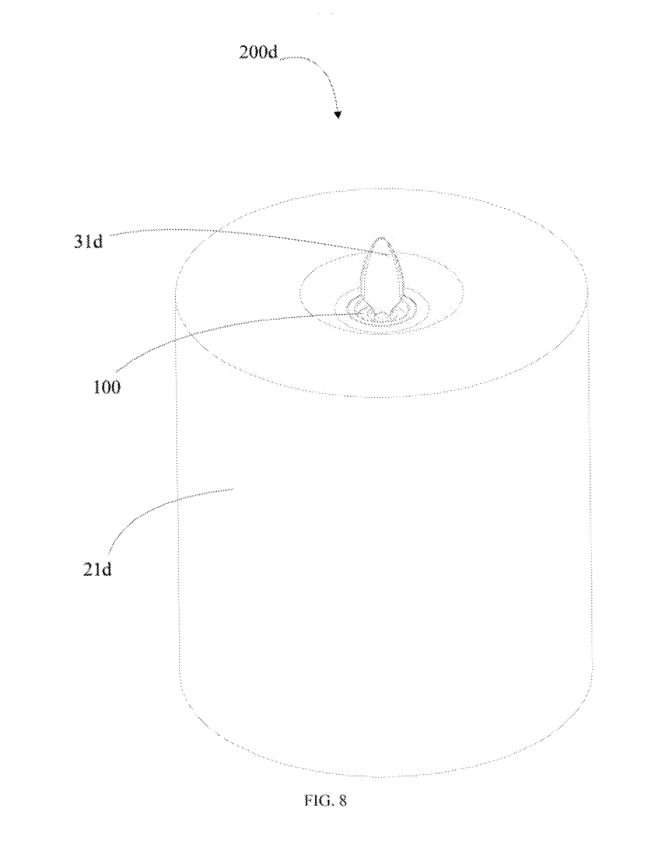

With reference to FIG. 8, the only difference between candle 200d in the third embodiment and candle 200a in the first embodiment is that the top of the shell 21d of candle 200d in the fourth embodiment does not form a curved salient.

It is understandable that the candle flame simulator 31d of the candle 200d in the third embodiment is located on the shell 21d swingingly.

The foregoing descriptions are merely embodiments of the present disclosure, and are not intended to limit the scope of the present disclosure. An equivalent structural or equivalent process alternation made by using the content of the specification and drawings of the present disclosure, or an application of the content of the specification and drawings directly or indirectly to another related technical field, shall fall within the protection scope of the present disclosure.

I claim:

1. A wax pool located on a top of a candle comprises:
at least a candle flame simulator;
wherein the wax pool is a light-transparent member, a reflection member or a 3D decoration member; the wax pool encircles the candle flame simulator.

2. The wax pool of claim 1, wherein the wax pool is provided with a through hole;
the candle flame simulator device is at least partially accommodated in the through hole, or adjacent to the through hole; and/or
the materials of the light-transmitting member are transparent plastic, translucent plastic, jelly wax, transparent wax, translucent wax, or glass; and/or
the wax pool has a gelatinous structure; and/or
the wax pool contains fragrance, essential oil, or insect repellent; and/or
the material of the reflecting member is mirror glass; or
the reflecting member is an annular member coated with reflective layer on the surface.

3. The wax pool of claim 2, wherein the wax pool is accommodated in a holder.

4. The wax pool of claim 3, wherein the holder comprises a basement and a bulge which is provided at a center of a basement; the basement and the bulge together form an accommodation space of the wax pool; the bulge passes through the through hole on the wax pool.

5. The wax pool of claim 4, wherein the bulge is provided with an opening;
the basement is provided with a hole to communicate with the opening of the bulge; the candle flame simulator passes through the opening and the hole; or, the candle flame simulator is disposed adjacent to the opening and the hole device thereof.

6. The wax pool of claim 4, wherein the holder also comprises a side wall which is located on a periphery of the basement; the basement, the side wall and the bulge together form an accommodation space.

7. The wax pool of claim 6, wherein the basement, the side wall or the bulge are provided with a heating plate.

8. A candle, comprises a shell, wherein the candle also comprises the wax pool of claim 1; the wax pool is located on a top of the shell.

9. The candle of claim 8, wherein the top of the shell is provided with a holding tank, the wax pool is accommodated in the holding tank; and/or
the candle further comprises a circuit board, a luminous part and a battery pack; the battery pack, the luminous part and the circuit board are electrically connected.

10. The candle of claim 8, wherein the candle flame simulator is fixed at a central position at the top of the shell; or
the candle flame simulator is accommodated in the shell; or
the shell is provided with a hole, the candle flame simulator is accommodated in the hole swingingly.
